(19) United States
(12) Patent Application Publication
(10) Pub. No.: US 2024/0248702 A1
(43) Pub. Date: Jul. 25, 2024

(54) FIRMWARE UPDATE TECHNOLOGIES

(71) Applicant: Intel Corporation, Santa Clara, CA (US)

(72) Inventors: Murugasamy K. NACHIMUTHU, Beaverton, OR (US); Yidong WU, Shanghai (CN); Jiaxin WU, Shanghai (CN); Ruixia LI, Shanghai (CN)

(21) Appl. No.: 18/289,558

(22) PCT Filed: Aug. 3, 2021
(86) PCT No.: PCT/CN2021/110181

§ 371 Date: Nov. 3, 2023

(51) Int. Cl. G06F 8/65

(52) U.S. Cl. CPC G06F 8/65

(57) ABSTRACT

It includes updating firmware on a device during operation of the device by: migrating a service executing on the device for execution on a second device; causing the device to enter a disabled state; storing the firmware for access by the device; and causing the device to reset, wherein the device reset comprises the device executing the stored firmware. It can include selecting a device to operate as a boot strap processor, wherein the selected device is one of a group of devices that are to execute the updated firmware and wherein the boot strap processor performs the causing the device to enter a disabled state, storing the firmware for access by the device, and causing the device to reset. The group of devices can comprise a group of threads within a central processing unit (CPU) socket. The group of devices can comprise central processing units (CPUs) within a CPU package.

### BACKGROUND

Computing devices utilize firmware for hardware initialization, low-level hardware management, and managing a boot process. In addition to the platform firmware, computing devices may also include dedicated firmware for controller chips, peripheral devices, or other components. Firmware can be read at runtime and in connection with a boot, but may be updated in connection with a firmware update process.

For example, after a release of a central processing unit (CPU), updating a CPU's firmware may need to occur via a microcode patch to address security, functional or performance issues or problems. Some microcode can be activated at runtime, but some microcode is to be activated by a Basic Input/Output System (BIOS) during an initialization phase, which requires a system reset of the CPU. For example, a system reset may be required in connection with changing CPU fuses or physical layer interface (PHY) settings (e.g., memory or Peripheral Component Interconnect Express (PCIe)). However, resetting a CPU involves disabling the CPU from performing work.

FIG. 1 depicts an example process to apply a microcode (uCode) patch. At 102, uCode activation by a BIOS can initiate a microcode patch, before a Boot Service. At 104, BIOS Exit Boot Service can include an indication from the operating system (OS) to the BIOS that the OS has completed using boot services of BIOS. BIOS Exit Boot Service can be called by a Universal Extensible Firmware Interface (UEFI) OS loader image to terminate all boot services. The UEFI OS loader becomes responsible for the continued operation of the system. At 106, during OS Runtime, BIOS services, other than Boot Service, can be utilized by the OS. At 108, uCode activating at OS kernel can include the OS kernel activating the uCode patch. A system reset can occur after the uCode is activated. For example, some uCode updates involve a socket reset.

Some Cloud Service Providers (CSPs) are sensitive to system reset because an impact to service uptime and system reset could violate a key performance indicator (KPI) of the CPU vendor. Rebooting a CPU can lead to system downtime in which the CPU is not able to execute workloads or latency of workload completion increases. CPU downtime can increase total cost of ownership (TCO) of a data center owner or operator. In some cases, CSPs can queue the patch and wait for a time to schedule the system reset to activate the patch, but this can prolong security risks. Some CSPs transfer the services to redundant servers during a microcode update.

### BRIEF DESCRIPTION OF THE DRAWINGS

FIG. 1 depicts an example process to apply a microcode patch.

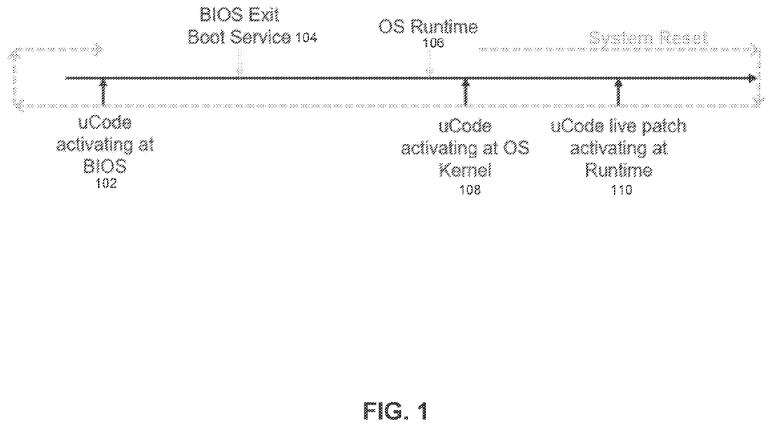

FIG. 2 depicts an overview of some examples.

FIG. 3 depicts an example system.

FIG. 4 depicts an example of operations to activate microcode on a device.

FIG. 5 depicts an example process.

FIG. 6 depicts an example system.

### DETAILED DESCRIPTION

In some examples, microcode loading and activating can occur in a serial manner to activate microcode on a first processor by migrating work performed on the first processor to a second processor, placing the first processor in a reduced power state, providing the microcode for access by the first processor, and causing the first processor to wake up, which can also cause loading of the microcode. Microcode can be activated on a processor by changing its state from offline to online.

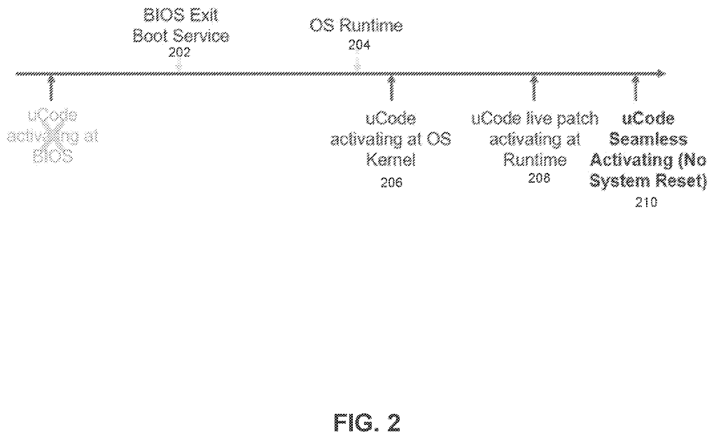

FIG. 2 provides an overview of operation. At 202, BIOS Exit Boot Service can include an indication from the operating system (OS) to BIOS that the OS has completed using boot services of BIOS. BIOS Exit Boot Service can be called by a Universal Extensible Firmware Interface (UEFI) OS loader image to terminate all boot services and the UEFI OS loader becomes responsible for the continued operation of the system. At 204, during OS Runtime, BIOS services, other than Boot Service, can be utilized by the OS. When the process of updating microcode firmware volumes to firmware storage (e.g., Serial Peripheral Interface (SPI) accessible flash) is completed, a System Management Interrupt (SMI) can cause transmission of a notification to the OS to start a process of microcode loading and activation. At 206, the OS kernel can migrate services executing on a target processor to another processor and causing the target processor to enter an idle state. At 208, uCode live patch activating at Runtime can include making available a microcode firmware volume for execution by the target processor. For example, a uCode patch could be applied at OS runtime by the OS writing to a register. At 210, the target processor can enter an operational state and execute the microcode firmware volume. The microcode firmware volume can include a firmware update.

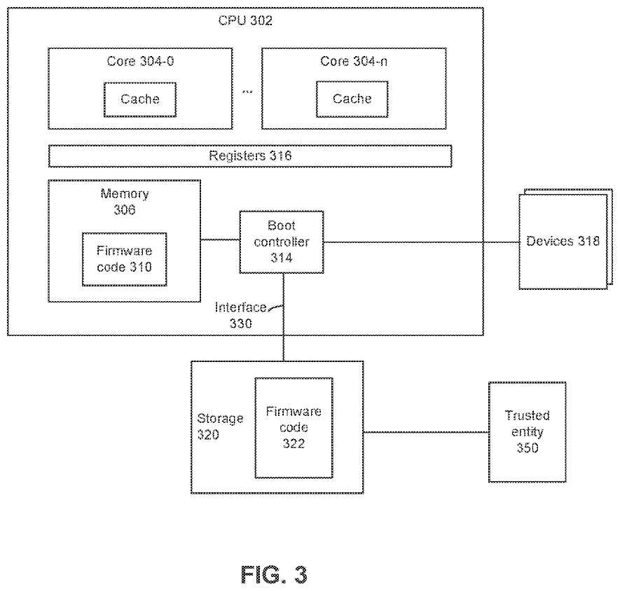

FIG. 3 depicts an example system. Central processing unit (CPU) 302 can include cores 304-0 to 304-n, where n is an integer. A core can be an execution core or computational engine that is capable of executing instructions. A core can have access to its own cache and read only memory (ROM), or multiple cores can share a cache or ROM. Cores can be homogeneous and/or heterogeneous devices. Any type of inter-processor communication techniques can be used, such as but not limited to messaging, inter-processor interrupts (IPI), inter-processor communications, and so forth. Cores can be connected in any type of manner, such as but not limited to, bus, ring, or mesh. A core may support one or more instructions sets (e.g., the x86 instruction set (with some extensions that have been added with newer versions)); the MIPS instruction set of MIPS Technologies of Sunnyvale, CA; the ARM instruction set (with optional additional extensions such as NEON) of ARM Holdings of Sunnyvale, CA), including the instruction(s) described herein. In addition or alternative to use of a CPU, an XPU or xPU could be used. An XPU can include one or more of: a graphics processing unit (GPU), general purpose GPU (GPGPU), field programmable gate arrays (FPGA), Accelerated Processing Unit (APU), accelerator, or another processor. In some examples, a CPU socket can provide an electrical connection between CPU 302 and a connector to a motherboard or circuit board and the motherboard or circuit board can provide an electrical interface to one or more other devices with CPU 302, such as devices 318, storage 320, and trusted entity 350.

One or more core 340-0 to 304-n can execute an operating system (OS). In some examples, the OS can be Linux®, Windows® Server or personal computer, Android®, MacOS®, iOS®, VMware vSphere, or any other operating system. The OS and driver can execute on a CPU or processor sold or designed by Intel®, ARM®, AMD®, Qualcomm®, IBM®, Texas Instruments®, among others.

One or more devices 318 can include one or more of: an XPU, infrastructure processing unit (IPU), CPU, CPU socket, graphics processing unit (GPU), processor, accelerator device, Board Management Controller (BMC), storage controller, memory controller, display engine, a peripheral device, Intel® Management or Manageability Engine (ME), AMD Platform Security Processor (PSP), ARM core with TrustZone extension, network interface device, Platform Controller Hub (PCH), application specific integrated circuit (ASIC), and so forth.

For example, an ME can include one or more processors and allow for powering on, configuring, controlling, or resetting a computer system via communications received using a network interface. For example, an ME can provide for fan speed control and monitoring of temperature, voltage, current and fan speed sensors. For example, an ME can provide secure audio video communication path. For example, an ME can provide a secure boot process by requiring firmware to be verified by its digital signature prior to boot. A PCH can include a chipset that provides data paths and a display interface, input/output controller, clock, and other circuitry.

Trusted entity 350 can include a BIOS, BMC or other hardware that can send commands to an ME or other device and write firmware to storage 320. For example, trusted entity 350 can transmit Intelligent Platform Management Interface (IPMI)-consistent commands to an ME or other device. Some examples provide a hot microcode patch update through an in-band channel and a hot microcode patch update through an out of band (OOB) channel. An in-band microcode patch update can be provided by a host such as a host OS. An OOB microcode patch update can be provided by another component than a host such as a BMC.

Boot firmware code or firmware can be associated with a header file that identifies a map of what boot code is to be copied by CPU 302. For example, a.h file for a firmware code can have a flash image layout map of which segments of the firmware code are to be copied. When executed by a processor, firmware code can be executed by a processor to perform hardware initialization during a booting process (e.g., power-on startup or restart), and provide runtime services for operating systems and programs. In some examples, boot firmware code or firmware can include one or more of: Basic Input/Output System (BIOS), video BIOS (VBIOS), GPU BIOS, Universal Extensible Firmware Interface (UEFI), or a boot loader. The BIOS firmware can be pre-installed on a personal computer's system board or accessible through an SPI interface from a boot storage (e.g., flash memory). In some examples, firmware can include SPS. In some examples, a Universal Extensible Firmware Interface (UEFI) can be used instead or in addition to a BIOS for booting or restarting cores or processors. UEFI is a specification that defines a software interface between an operating system and platform firmware. UEFI can read from entries from disk partitions by not just booting from a disk or storage but booting from a specific boot loader in a specific location on a specific disk or storage. UEFI can support remote diagnostics and repair of computers, even with no operating system installed. A boot loader can be written for UEFI and can be instructions that a boot code firmware can execute and the boot loader is to boot the operating system(s). A UEFI bootloader can be a bootloader capable of reading from a UEFI type firmware.

A UEFI capsule is a manner of encapsulating a binary image for firmware code updates. But in some examples, the UEFI capsule is used to update a runtime component of the firmware code. The UEFI capsule can include updatable binary images with relocatable Portable Executable (PE) file format for executable or dynamic linked library (dll) files based on COFF (Common Object File Format). For example, the UEFI capsule can include executable (*.exe) files. This UEFI capsule can be deployed to a target platform as an SMM image via existing OS specific techniques (e.g., Windows Update for Azure, or LVFS for Linux).

In some examples, boot controller 314 can access firmware code 322 from storage 320 and copy the firmware code 310 to a memory device for execution by one or more of cores 304-0 to 304-n and/or one or more of devices 318 for execution after exiting from idle state. In some examples, as described herein, boot controller 314 can be implemented by one or more of cores 304-0 to 304-n or a thread of a core. Boot controller 314 can be implemented as any type of controller (e.g., microcontroller) or processor capable of managing firmware code loading and storage into memory 306 for access by a core (e.g., any of 304-0 to 304-n) or one or more of devices 318. In some examples, boot controller 314 can be implemented using a CPU core (e.g., any of 304-0 to 304-n) or a thread of a multi-threaded core. In some examples, boot controller 314 can be coupled to storage 320 using interface 330.

Interface 330 can provide communication using one or more of the following protocols: serial peripheral interface (SPI), enhanced SPI (eSPI), System Management Bus (SMBus), I2C, MIPI I3C®, Peripheral Component Interconnect Express (PCIe), Compute Express Link (CXL). See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof. In some examples, storage 320 can be connected to boot controller 314 using a fabric or network and a firmware update can be transmitted using one or more packets via a fabric or network interface (not shown).

For a CPU package-wide patch load, microcode can be applied on all processors in a package. For example, changing fit binding microcode may require a reset of all processors in a CPU package. In some examples, for a package-wide uniform patch load, one or more services executed by CPU, whose microcode is to be updated or changed, can be migrated for execution on a CPU in another package. The one or more processors in a target CPU package can be set to offline state. The microcode can be made available for execution by one or more processors in a target CPU package. The one or more processors in the target CPU package can be changed from offline to online as a group in order to activate execution of microcode of the processors on the target CPU package. Accordingly, a new or formerly executed service or function component in firmware image can be added at runtime to a device. Run-time microcode or firmware patches can be deployed for various central processing unit (CPU) firmware engines to fix bugs (errors), introduce newer capabilities, or revert to a prior firmware version. In other words, seamless activation of microcode in a system can occur using CPU hot plugging or hot adding with a CPU partial reset.

In some examples, for a non-uniform patch load, microcode of some but not all processors (e.g., cores) in a CPU package can be updated by initiating microcode update by idling or causing the processors whose microcode is to be reset.

In some examples, a target device whose microcode is to be updated or changed can be a core of a CPU. For a microcode change on a first core, a service executing on the first core can be migrated to execute on a second core in a same or different CPU package as that of the first core. The first core can be disabled and microcode can be loaded to microcode read only memory (ROM) or other memory or storage and available for access for the first core to execute the microcode. The disabled first core can be enabled to enter a reset flow and entering a reset flow can cause the first core to apply the firmware patch.

In some examples, a target CPU whose microcode is to be updated or changed can be a thread of a multi-threaded core. For a microcode change on a first thread, a service executing on the first thread can be migrated to execute on a second thread. The first thread can be disabled and microcode can be available for access for the first thread to execute the microcode. The disabled first thread can be enabled to enter a reset flow and entering a reset flow can cause the first thread to apply the firmware patch.

In some cases, microcode can be loaded from a Firmware Interface Table (FIT) and in order to be fully effective, a system reset occurs.

For example, BIOS Init code to wakeup a device and cause execution of a microcode patch can include a call stack as follows:

MicrocodeDetect (CpuMpData, CpuMpData−>BspNumber); /// Detect and apply
Microcode on BSP
MtrrGetAllMtrrs (&CpuMpData−>MtrrTable); /// Store BSP's Microcode and Memory
type range register (MTRR) setting
WakeUpAP (CpuMpData, TRUE, 0, ApInitializeSync, CpuMpData, TRUE); /// Wakeup
CPU or thread to perform initialization synchronization of MTRRs
SendInitSipiSipiAllExcludingSelf ((UINT32) ExchangeInfo−>BufferStart); /// Wakeup
application processors (APs) via InitSipiSipi command
RendezvousFunnelAddress −> ApWakeupFunction −> ApFunction (ApInitializeSync) −>
MicrocodeDetect /// patch/active the uCode

An application processor (AP) can be a thread of a multi-thread core, a core, or a device in some examples.

Operation of memory (e.g., memory 306) and I/O devices (e.g., buses or network interface devices) can be maintained online during microcode updating and activation to attempt to avoid disrupting services on a CPU.

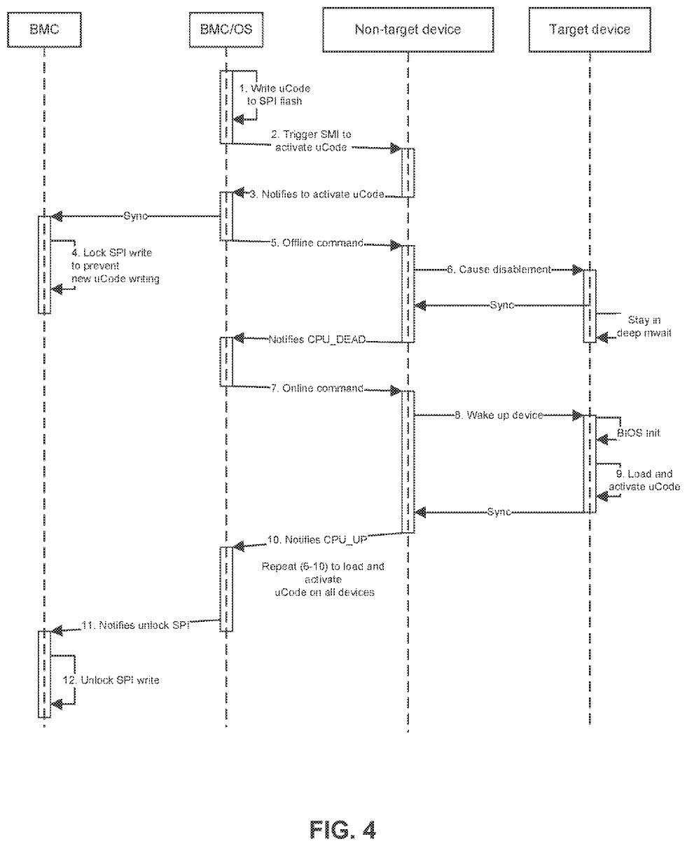

FIG. 4 depicts an example flow of operations to activate microcode on a device. An orchestrator can send a microcode firmware volume (FV) to be written to a firmware storage. At (1), a host OS (e.g., OS System management mode (SMM)) or BMC can cause the microcode FV image to be written to firmware storage. In some examples, firmware storage can include SPI accessible flash storage. Firmware storage can be written-to or read-from using an in-band channel. In some examples, the BMC can copy the microcode FV image to firmware storage through an out of band (OOB) channel. SMM can be an operating mode of some CPUs in which process execution, including OS execution, is suspended.

At (2), when or after the FV image is copied to firmware storage, the BMC or the OS can trigger a System Management Interrupt (SMI) to the non-target device to initiate boot loading operations on one or more other devices. The non-target device can operate as a bootstrap processor (BSP) for one or more other devices. Various examples of devices are described herein.

At (3), in response to the SMI, the BSP can notify the OS to start microcode FV loading and activation on a target device. At (4), in response to commencement of microcode FV loading and activation on a target device, the BMC can lock writing to the firmware storage to prevent another microcode from being written to the firmware storage during the microcode activation.

At (5), the BMC or OS can cause the BSP to trigger the target device, on which microcode will be activated, to enter an offline state. At (6), the BSP can send a command to cause the target device to enter offline state and disable operation of the target device. The target device can be in a Monitor Wait (MWAIT) or a C state such as C1, C2, C3, C4, C5, or C6 that provide for one or more of: reduced clock frequency to the device, reduced power to the device bus interface, or reduced voltage to the device.

Prior to entering offline state and disabling operation of the target device, the target device can migrate services executing on the target device to one or more other non-target devices and non-BSP device. In some examples, a BIOS executed by a device can request the OS to reschedule a thread on another device that is not being reset. For example, an OS scheduler can monitor levels of activity of devices, including one or more other non-target devices and non-BSP device and determine which online non-target and non-BSP device is to execute the service by load balance execution of services. In some examples, the target device can migrate services for execution on another device. The target device can inform the BSP that the target device is in a dead state or sleep state. The BSP can inform the BMC or OS that the device is in a dead or sleep state. If the device is a CPU, a notification that the CPU is in a dead or sleep state to the BMC or OS can be CPU_DEAD.

At (7), the OS or BMC can send a device online command to the BSP to cause activation of the target device in dead or sleep state and at (8), the BSP can send a command to the target device in dead or sleep state to enter online or higher power state. As part of (8), the BSP can send a INIT-SIPI-SIPI to the target device in dead or sleep state to enter online or higher power state. At (9), the target device in dead or sleep state can be awaken and execute firmware initialization code. Execution of firmware initialization code can cause the patch of microcode FV to be loaded and activated. At (10), the BSP can notify the BMC or OS that a target device, whose microcode FV was loaded and activated, is operational. If the device is a CPU, the notification can be CPU_UP.

One or more of operations or actions (6)-(10) can repeat to load and activate microcode FV on a group of devices by selection of another device to operate as a BSP for another target device, whose microcode FV has not yet been patched, until all target devices have had microcode FV loaded and activated.

At (11), the OS can instruct the BMC to unlock access to the firmware storage and allow microcode to be written to the firmware storage and at (12), the BMC can allow access to the firmware storage and allow other microcode to be written to the firmware storage, such as for another firmware update.

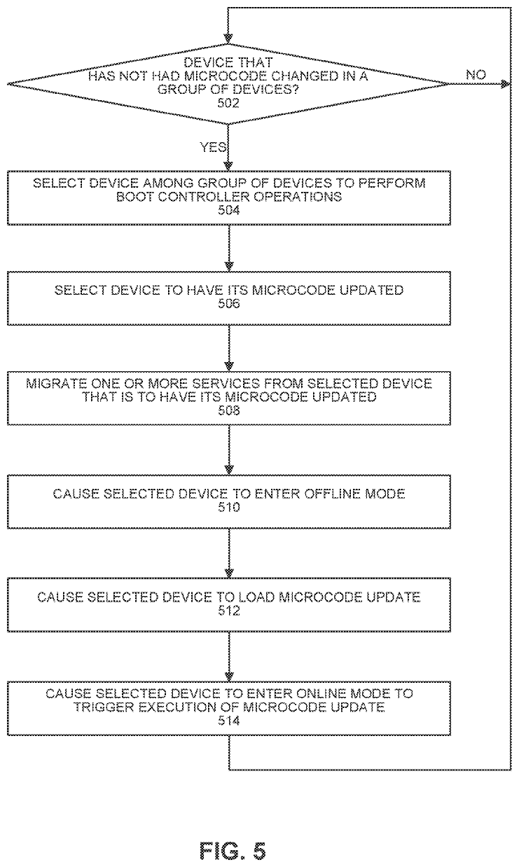

FIG. 5 depicts an example process that can be used to update firmware on a device. At 502, based on receipt of a request to update a firmware of a device, a determination can be made if a device in a group of devices has not had microcode patched. If a device has not had microcode patched, the process continues to 504. If all devices in a group of devices have had their microcode patched, 502 can repeat.

At 504, a device can be selected to operate as a boot controller. The device can be a processor whose microcode has been patched in some cases. The device can include one or more of: an XPU, infrastructure processing unit (IPU), CPU, CPU socket, graphics processing unit (GPU), processor, accelerator device, Board Management Controller (BMC), storage controller, memory controller, display engine, a peripheral device, Intel® Management or Manageability Engine (ME), AMD Platform Security Processor (PSP), ARM core with TrustZone extension, network interface device, Platform Controller Hub (PCH), application specific integrated circuit (ASIC), and so forth. At 506, a device, that is not boot controller and whose microcode has not been updated, can be selected to be a target device.

At 508, the boot controller can cause migration of services executed on the selected target device to execution on another device. The another device can be a processor in a same socket or another device connected to a same motherboard, in a same server, in a rack of servers, or remotely accessible through a network or fabric. At 510, the selected device can enter offline mode. At 512, the boot controller can cause the selected target device to load the microcode that is to be executed. At 514, the boot controller can cause the boot controller to enter online mode. Entering online mode can cause the boot controller to execute the loaded microcode. The process can return to 502.

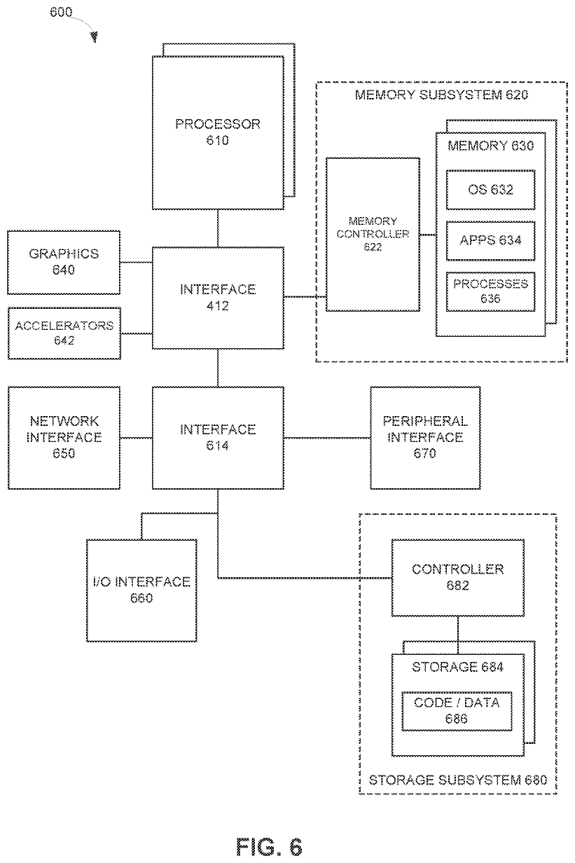

FIG. 6 depicts a system. Various examples can be used by system 600 or its components to update or access an updated firmware as described herein. System 600 includes processor 610, which provides processing, operation management, and execution of instructions for system 600. Processor 610 can include any type of microprocessor, central processing unit (CPU), graphics processing unit (GPU), Accelerated Processing Unit (APU), processing core, or other processing hardware to provide processing for system 600, or a combination of processors. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. As described herein, microcode of a processor 610 can be updated by an offline-to-online operation and allowing a workload performed by such processor to be executed by another processor.

In one example, system 600 includes interface 612 coupled to processor 610, which can represent a higher speed interface or a high throughput interface for system components that needs higher bandwidth connections, such as memory subsystem 620 or graphics interface 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a high definition (HD) display that provides an output to a user. High definition can refer to a display having a pixel density of approximately 100 PPI (pixels per inch) or greater and can include formats such as full HD (e.g., 1180p), retina displays, 6K (ultra-high definition or UHD), or others. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide sequential and speculative decoding operations in a manner described herein, compression (DC) capability, cryptography services such as public key encryption (PKE), cipher, hash/authentication capabilities, decryption, or other capabilities or services. In some embodiments, in addition or alternatively, an accelerator among accelerators 642 provides field select controller capabilities as described herein. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory. Network interface 650 can receive data from a remote device, which can include storing received data into memory. As described herein, microcode of a processor 610, memory subsystem 620, network interface 650, or an accelerator 642 can be updated by an offline-to-online operation and allowing a workload performed by such processor to be executed by another processor or accelerator.

In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 646 in a persistent state (i.e., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (i.e., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory is memory whose state (and therefore the data stored in it) is indeterminate if power is interrupted to the device. Dynamic volatile memory can involve refreshing the data stored in the device to maintain state. One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications.

A non-volatile memory (NVM) device is a memory whose state is determinate even if power is interrupted to the device. In some examples, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 600. More specifically, power source typically interfaces to one or multiple power supplies in system 600 to provide power to the components of system 600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 600 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (ROCE), Peripheral Component Interconnect express (PCIe), Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (i.e., buses) for coupling appropriate integrated circuits (ICs) and other components mounted to the board.

Various examples can be used in a base station that supports communications using wired or wireless protocols (e.g., 3GPP Long Term Evolution (LTE) (4G) or 3GPP 5G), on-premises data centers, off-premises data centers, edge network elements, edge servers and switches, fog network elements, and/or hybrid data centers (e.g., data center that use virtualization, cloud and software-defined networking to deliver application workloads across physical data centers and distributed multi-cloud environments).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (i.e., buses) for coupling appropriate integrated circuits (ICs) and other components mounted to the board.

In some examples, network interface and other examples described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements. Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in examples.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative examples. Furthermore, additional operations may be added or removed depending on the particular applications. Any combination of changes can be used and one of ordinary skill in the art with the benefit of this disclosure would understand the many variations, modifications, and alternative examples thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An example of the devices, systems, and methods may include any one or more, and any combination of, the examples described below.

Example 1 includes one or more examples and includes a method comprising: updating firmware on a device during operation of the device by: migrating a service executing on the device for execution on a second device; causing the device to enter a disabled state; storing the firmware for access by the device; and causing the device to reset, wherein the device reset comprises the device executing the stored firmware.

Example 2 includes one or more examples and includes selecting a device to operate as a boot strap processor, wherein the selected device is one of a group of devices that are to execute the updated firmware and wherein the boot strap processor performs the causing the device to enter a disabled state, storing the firmware for access by the device, and causing the device to reset.

Example 3 includes one or more examples, wherein the group of devices comprise a group of threads within a central processing unit (CPU) socket.

Example 4 includes one or more examples, wherein the group of devices comprise central processing units (CPUs) within a CPU package.

Example 5 includes one or more examples, wherein the migrating a service executing on the device for execution on a second device comprises: selecting the second device from among one or more processors to which the updated firmware is to be applied.

Example 6 includes one or more examples, wherein the firmware comprises a microcode firmware volume (FV).

Example 7 includes one or more examples, wherein the device comprises one or more of: a multi-thread core, a central processing unit (CPU), an XPU, a graphics processing unit (GPU), a network interface device, or application specific integrated circuit (ASIC).

Example 8 includes one or more examples, and includes a system comprising: at least one processor and circuitry to update firmware on a first processor of the at least one processor during operation of the first processor by: cause migration of a service executing on the first processor to a second processor of the at least one processor; cause the first processor to enter an idle state; and cause the first processor to exit from idle state, wherein the exit from idle state is to cause the first processor to execute the firmware.

Example 9 includes one or more examples, wherein the circuitry is to provide the firmware to the first processor when the first processor is in the idle state.

Example 10 includes one or more examples, wherein the circuitry comprises a boot strap processor and wherein the circuitry comprises a processor to which the updated firmware is to be applied or has been applied.

Example 11 includes one or more examples, wherein the at least one processor comprises a group of one or more threads within a central processing unit (CPU).

Example 12 includes one or more examples, wherein the at least one processor comprises central processing unit (CPU) within a CPU package.

Example 13 includes one or more examples, wherein the second processor is selected based on not having the firmware update applied.

Example 14 includes one or more examples, wherein the firmware comprises a microcode update.

Example 15 includes one or more examples, and includes a baseboard management controller (BMC) to cause the firmware update on the at least one processor.

Example 16 includes one or more examples, wherein the first processor comprises one or more of: a multi-thread core, a central processing unit (CPU), an XPU, a graphics processing unit (GPU), a network interface device, or application specific integrated circuit (ASIC).

Example 17 includes one or more examples, wherein the second processor is in a same CPU package as that of the first processor or the second processor is connected to a same circuit board as that of the first processor.

Example 18 includes one or more examples, and includes a computer-readable medium comprising instructions stored thereon, that if executed by one or more processors, cause the one or more processors to: migrate a service executing on a device for execution on a second device; cause the device to enter a disabled state; store firmware for access by the device; and cause the device to enter a reset flow, wherein the device entering a reset flow comprises the device executing the stored firmware.

Example 19 includes one or more examples, wherein a processor is to operate as a boot strap processor and the boot strap processor performs the cause the device to enter a disabled state, store firmware for access by the device and cause the device to enter a reset flow.

Example 20 includes one or more examples, wherein the migrate a service executing on the device for execution on a second device comprises: selecting the second device from among one or more devices to which the firmware is to be applied.

Example 21 includes one or more examples, wherein the device comprises one or more of: a multi-thread core, a central processing unit (CPU), an XPU, a graphics processing unit (GPU), a network interface device, or application specific integrated circuit (ASIC).

1.-21. (canceled)

22. A method comprising:
updating firmware on a device during operation of the device by:
migrating a service executing on the device for execution on a second device;
causing the device to enter a disabled state;
storing the firmware for access by the device; and
causing the device to reset, wherein the device to reset comprises the device executing the stored firmware.

23. The method of claim 22, comprising:
selecting a device to operate as a boot strap processor, wherein the selected device is one of a group of devices that are to execute the updated firmware and wherein the boot strap processor performs the causing the device to enter a disabled state, storing the firmware for access by the device, and causing the device to reset.

24. The method of claim 23, wherein the group of devices comprise a group of threads within a central processing unit (CPU) socket.

25. The method of claim 23, wherein the group of devices comprise central processing units (CPUs) within a CPU package.

26. The method of claim 22, wherein the migrating a service executing on the device for execution on a second device comprises:
selecting the second device from among one or more processors to which the updated firmware is to be applied.

27. The method of claim 22, wherein the firmware comprises a microcode firmware volume (FV).

28. The method of claim 22, wherein the device comprises one or more of: a multi-thread core, a central processing unit (CPU), an XPU, a graphics processing unit (GPU), a network interface device, or application specific integrated circuit (ASIC).

29. A system comprising:
at least one processor and
circuitry to update firmware on a first processor of the at least one processor during operation of the first processor by:
cause migration of a service executing on the first processor to a second processor of the at least one processor;
cause the first processor to enter an idle state; and
cause the first processor to exit from idle state, wherein the exit from idle state is to cause the first processor to execute the firmware.

30. The system of claim 29, wherein the circuitry is to provide the firmware to the first processor when the first processor is in the idle state.

31. The system of claim 29, wherein the circuitry comprises a boot strap processor and wherein the circuitry comprises a processor to which the updated firmware is to be applied or has been applied.

32. The system of claim 29, wherein the at least one processor comprises a group of one or more threads within a central processing unit (CPU).

33. The system of claim 29, wherein the at least one processor comprises central processing unit (CPU) within a CPU package.

34. The system of claim 29, wherein the second processor is selected based on not having the firmware update applied.

35. The system of claim 29, wherein the firmware comprises a microcode update.

36. The system of claim 29, comprising:
a baseboard management controller (BMC) to cause the firmware update on the at least one processor.

37. The system of claim 29, wherein the first processor comprises one or more of: a multi-thread core, a central processing unit (CPU), an XPU, a graphics processing unit (GPU), a network interface device, or application specific integrated circuit (ASIC).

38. The system of claim 29, wherein the second processor is in a same CPU package as that of the first processor or the second processor is connected to a same circuit board as that of the first processor.

39. A computer-readable medium comprising instructions stored thereon, that if executed by one or more processors, cause the one or more processors to:
migrate a service executing on a device for execution on a second device;
cause the device to enter a disabled state;
store firmware for access by the device; and
cause the device to enter a reset flow, wherein the device entering a reset flow comprises the device executing the stored firmware.

40. The computer-readable medium of claim 39, wherein a processor is to operate as a boot strap processor and the boot strap processor performs the cause the device to enter a disabled state, store firmware for access by the device and cause the device to enter a reset flow.

41. The computer-readable medium of claim 39, wherein the migrate a service executing on the device for execution on a second device comprises:
selecting the second device from among one or more devices to which the firmware is to be applied.

42. The computer-readable medium of claim 39, wherein the device comprises one or more of: a multi-thread core, a central processing unit (CPU), an XPU, a graphics processing unit (GPU), a network interface device, or application specific integrated circuit (ASIC).
